(19) United States
(12) Patent Application Publication
(10) Pub. No.: US 2003/0190087 A1
(43) Pub. Date: Oct. 9, 2003

(54) Automatic detection of vertical scratches in digital images

(76) Inventor: Alexander Kobilansky, Ossinging, NY (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/371,924

(22) Filed: Feb. 21, 2003

Related U.S. Application Data
(60) Provisional application No. 60/370,534, filed on Apr. 5, 2002.

(51) Int. Cl. G06K 9/40

(52) U.S. Cl. 382/275

(57) ABSTRACT

A method for detecting and repairing vertical scratches in a digital image. The method comprises the steps of detecting positions of pixels having a significant value deviation from a horizontally averaged value. The number of detected positions within a pre-defined distance in the same vertical column containing the pixel are counted. A pixel is flagged as a scratch site whenever the count of detected positions exceeds a pre-defined threshold. The flagged pixels are binary mapped, morphologically processed and repaired.

This invention relates generally to the field of digital image restoration and more specifically to a process for automatic detection of vertical scratches found in images originated from motion picture film.

### BACKGROUND OF THE INVENTION

Photographic film has been the recording media of choice for motion picture industry largely because of technical advantages which include high dynamic range, natural soft clipping, good color reproduction, and high reliability. Another advantage is the traditional consumer acceptance. However, one disadvantage of film origination is a high rate of image defects resulting from physical or chemical damage to the film.

The advent of high quality means for delivering motion picture content to consumers, like high-definition TV and DVD, have raised quality requirements for the original content. Furthermore there is a growing demand for inexpensive technologies for concealing image defects resulting from physical damage to the physical image carrier.

Vertical scratches are among the most annoying defect characteristics of motion picture film. These defects result from mechanical damage to the film, usually caused by abrasive particles that are caught by various elements of the film track or path during recording, copying, and scanning.

A well known economic way to conceal vertical scratches is to use a so called wet gate technique, where the damaged film is immersed in liquid during scanning. Wet gate technology helps to conceal shallow scratches in the scanned film. However, this technique poses a serious health and safety issues. Wet gate technique does not help in the repair of deeper scratches that affected at least one color layer of the film emulsion. Neither does it conceal defects originated in previous copies of the film.

Powerful technologies for motion picture restoration may be implemented in digital domain, i.e. after film is scanned and converted to digital stream or file sequence. Once prohibitively expensive, digitization of motion picture films became routine practice in post-production film industry. The transition to digital processing has been facilitated by advent of high performance Spirit™ and Specter™ (trade marks of Thomson) tines of equipment and software, produced first by Royal Philips electronics NL, and subsequently by Thomson, headquartered in France. Typically a motion picture film is digitized, and then all editing, color grading, creation of transitions between scenes, and special effects are performed on image file sequences using combinations of specialized hardware and software running on general purpose computers. Digital film restoration fits into this contemporary sequence of film post-production.

Software applications for digital film and video restoration are commercially available from, for example da Vinci Systems, Inc. of Fort Lauderdale, Fla., and from Mathematical Technologies, Inc. of Providence, R.I. There are also many products on the market that have limited functionality, but offer fast real-time electronic noise reduction. An example is Scream™ (trade mark of Thomson), a high resolution digital noise reducer produced by Thomson as an option for Spirit film scanner.

An overview of digital algorithms for repairing motion picture film and video is presented in a book by Dr. Anil Kokaram, “Motion Picture Restoration,” Springer-Verlag London Limited, 1998. Algorithms for vertical scratch recognition involve calculation of a Hough transform of binary defect map. However, the described procedure has several limitations. First, it has high computational complexity because the Hough transform is a global operation. Second, fine scene dependent adjustment of detection parameters is required. Third, scratches are required to be straight and cross whole image. These limitations decrease the value of this technique as an element of a low cost, high performance automatic restoration system.

With respect to vertical scratch detection and repair, none of the existing digital tools provide a satisfactory solution. For example, products from da Vinchi and MTI require human intervention to identify each vertical scratch. Hence, there is a need for an algorithm that can provide automatic detection of vertical scratches, that is consistent with an operator's perception and detection of vertical scratches.

Once a vertical scratch is correctly detected, it may be repaired using one of proven techniques, for example using 2D Autoregressive model as described in aforementioned book. This invention concerns detection of vertical scratches and does not provide details of known repair techniques, however, a complete software or hardware system will involve the steps of both detection and repair.

### SUMMARY OF THE INVENTION

An inventive arrangement provides an economic and robust algorithm for the automatic detection and concealment of vertical scratches. In this inventive algorithm the global Hough transform is advantageously replaced with a local operation for calculating vertical rank of suspected defect sites.

An inventive method for detecting and repairing vertical scratches in a digital image, comprises the steps of, detecting positions of significant deviations of pixel values from horizontally averaged values. For each image pixel, counting a number of the detected positions within a pre-defined distance in the same vertical column containing each image pixel. Flagging a pixel as a scratch site whenever a count of the detected positions exceeds a pre-defined threshold. Morphological processing a binary map of the flagged pixels, and repairing the flagged pixels.

In a further inventive method the digital image is a member of a motion picture image sequence, and the same vertical column can extend beyond the boundary of the image by including adjacent images from the same sequence.

In yet a further inventive method the detection of positions of pixel values with significant deviation from the horizontally averaged values, comprises, low-pass vertical filtering of original image, and high-pass horizontal filtering of the resultant image. Creating a binary map which flags each pixel of the filtered image having an absolute value that exceeds a pre-defined threshold.

In another inventive method the binary map which flags each pixel of the filtered image having an absolute value that exceeds a pre-defined threshold is morphological processed by applying operations of dilation and possibly erosion to the whole binary map. In addition the morphological processing can advantageously include the addition to the binary map of pixels horizontally adjacent to any of the flagged pixels to provide a horizontal dilation function.

In yet another inventive method the steps of counting, flagging and morphological processing are performed two or more times using different ranking and morphological parameters values in order to improve detection of meandering and disconnected scratches.

An inventive device for detecting and repairing vertical scratches in a digital image implements the image processing steps of; detecting positions of significant deviations of pixel values from horizontally averaged values; for each image pixel, counting a number of detected positions within a pre-defined distance in the same vertical column as each image pixel; flagging the pixel as a scratch site whenever the count exceeds a pre-defined threshold; morphological processing a binary map of the flagged pixels, and repairing the digital image at the flagged pixels.

### BRIEF DESCRIPTION OF THE DRAWINGS

FIG. 1 is an exemplary block diagram using inventive arrangements for digital image restoration implemented in software.

FIG. 2 is an exemplary hardware implementation using the inventive arrangements for digital image restoration.

FIG. 3 shows a known sequence of steps employed for the detection and repair of vertical scratches.

FIG. 4 shows the inventive sequence employed in FIGS. 1 and 2 for the detection and repair of vertical scratches.

FIG. 5 shows an inventive vertical rank thresholding.

### DESCRIPTION OF THE INVENTION

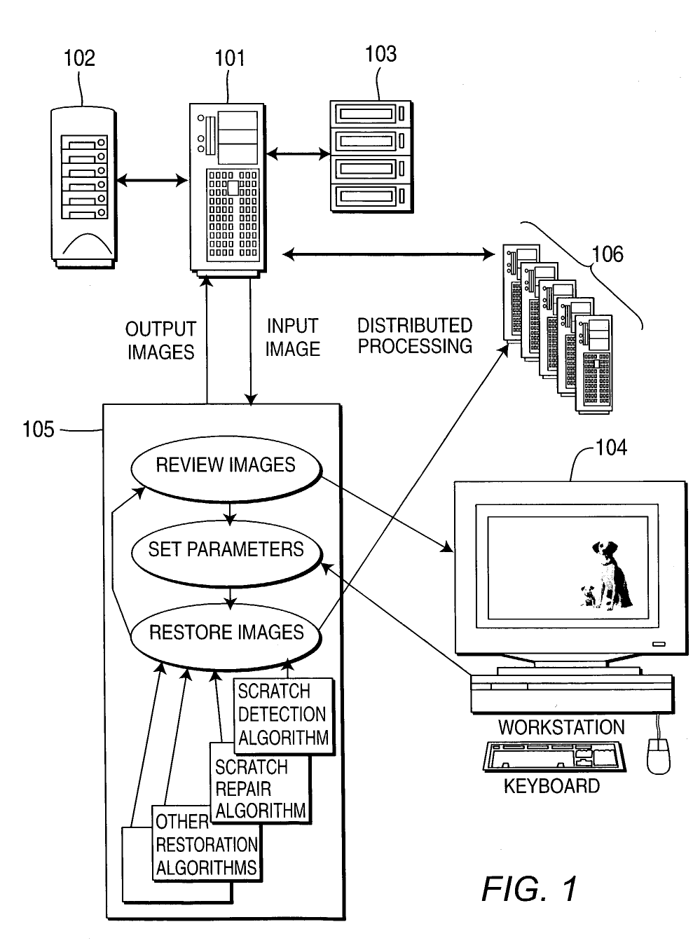

The exemplary block diagram of FIG. 1 shows a software-based image restoration arrangement employing the inventive arrangements. A file server 101 controls high volume storage facilities, including RAID disk array 102 and tape drives 103. An operator controls the process of restoration using workstation 104 which runs software package 105. Various software tools are provided which allow the operator to review images, adjust content-dependent parameters that control restoration, and initiate the automatic restoration process. The restoration computer program implements the inventive scratch detection, scratch repair, and other defect detection and repair algorithms. In many contemporary facilities complex image processing calculations are distributed among multiple servers connected as so called server farms 106. Restored images are returned to file storage, 102, and or 103 under the control of the file server 101.

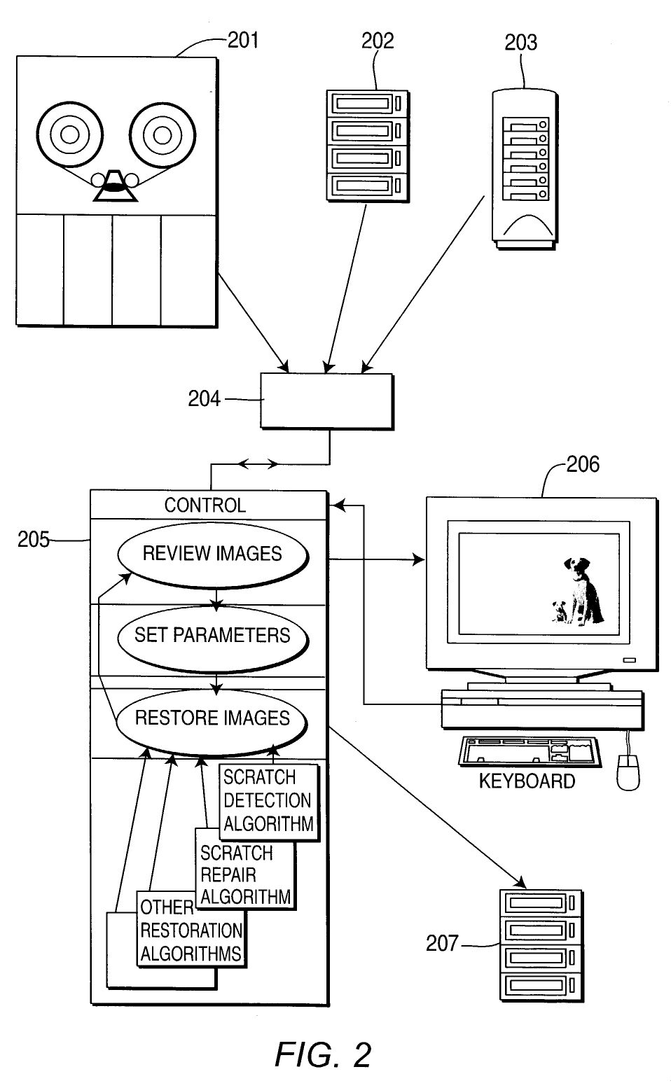

FIG. 2 shows an exemplary hardware-based arrangement for digital image restoration. Input material is provided as a data streams 201a, 202a, 203a, from real-time sources, for example, digital film scanner or so called datacini 201, video tape 202, or high speed disk array 203. Switch 204 allows selection between the various input bit stream sources. A digital film restoration device 205 includes electronic modules that provide control of the image sources and facilitate the review of the selected image stream, setting restoration parameters, and implementation of the automatic restoration of the input images. A restoration module within device 205 contains electronic circuitry for implementing the inventive scratch detection, scratch repair, and other defect detection and repair algorithms. Using monitor 206 the operator adjusts parameters of these algorithms to optimize the fidelity of restored images. The stream of restored images is then stored, for example, on recorder 207. FIGS. 1 and 2 show exemplary embodiments in both software and hardware, however the invention is not so limited and may be implemented with a combination of hardware, software and or firmware.

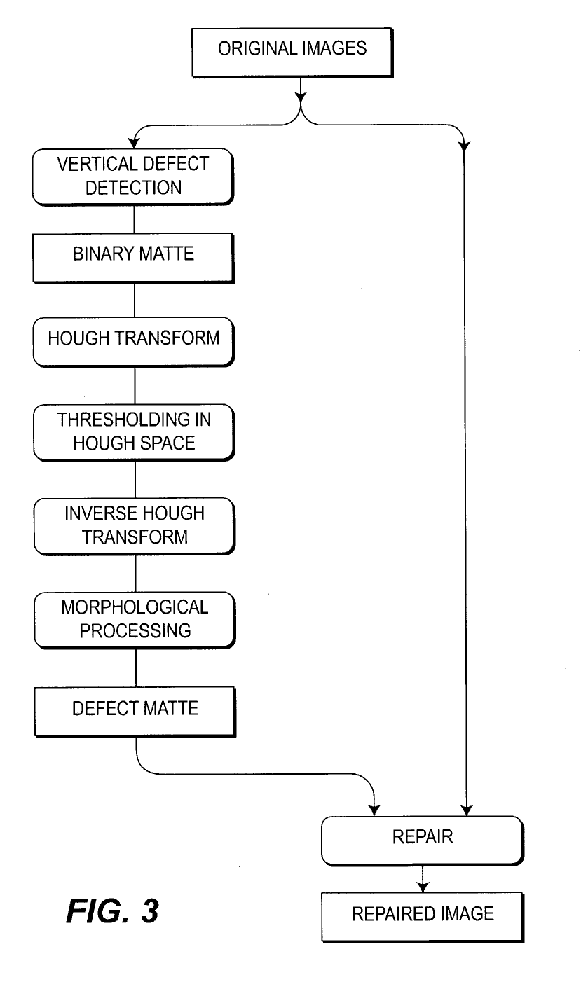

FIG. 3 illustrates a known image processing sequence for vertical scratch detection where the original images are processed one at a time. In the processing sequence of FIG. 3, vertical defect detection creates a binary matte which flags pixels that have a higher probability of belonging to vertical scratches. The vertical scratch detection procedure includes;

(1) vertical low-pass filtering, preferably using Gaussian convolution of original image,

(2) horizontal high-pass filtering, preferably high-pass median filtering, and

(3) thresholding the result to create binary matte.

A Hough transform maps straight lines in a binary matte onto points in Hough space. Peaks within the Hough space that exceed a pre-defined threshold and whose position correspond to nearly vertical lines correspond to suspect vertical scratches. Inverse Hough transform maps these peaks back into image space. In practice, additional morphological processing is required to dilate (widen) and merge close lines. The resulting defect matte is used as a key for the repair process.

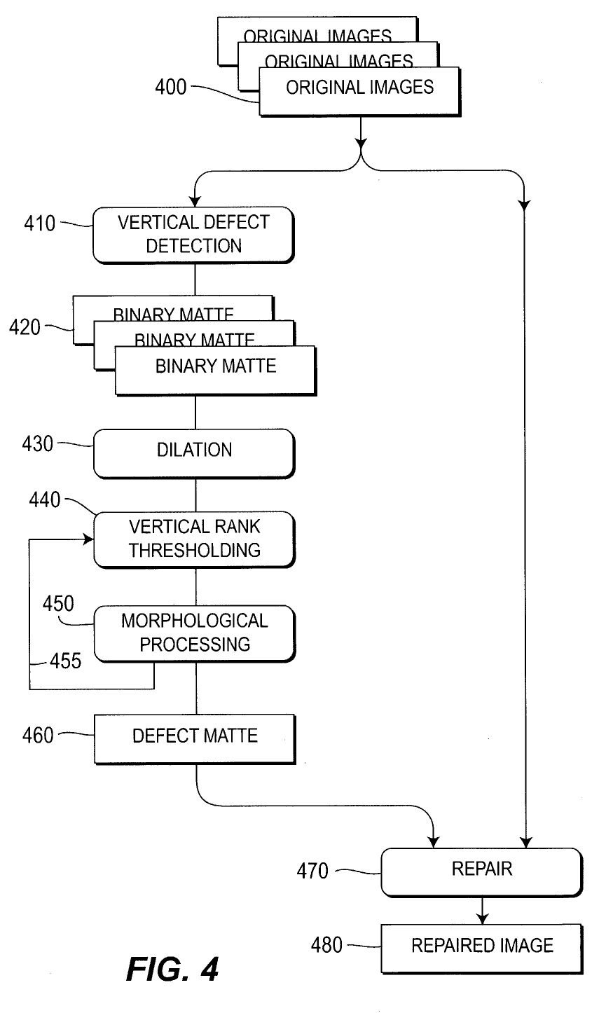

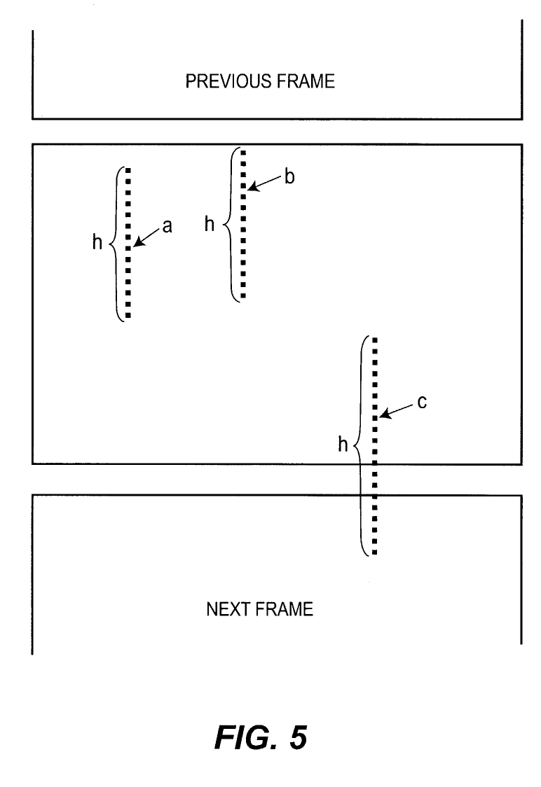

An inventive processing arrangement is shown in FIG. 4. Most noticeably, the direct Hough transform, thresholding in Hough space, and inverse transform of FIG. 3, is advantageously replaced in FIG. 4 by a combination of vertical rank thresholding and morphological processing performed one or more times. Vertical rank thresholding is described with reference to FIG. 5. Morphological processing advantageously employs horizontal dilation, which enhances the detection of scratches that deviate from straight vertical lines.

A further difference from the known process of FIG. 3 is that the inventive vertical ranking method of FIG. 4 allows the processing of more than one consecutive frame in an image sequence. This advantageously recognizes and exploits the fact that vertical scratches usually persist for many frames, unlike the processing method of FIG. 3 where images are processed one at a time. In addition, by advantageously extending vertical scratch detection to consecutive frames the robustness of the detection is improved. However, this improvement is not limited to multiple frame images since the method of FIG. 4 is equally applicable to isolated or individual frames.

The processing sequence of FIG. 4 starts at step 400 where a first image of a plurality images is input for processing. Vertical defect detection is performed at step 410 with detected defect pixels formed as a first binary matte of a plurality, corresponding to the plurality of input images (420). The defect pixel matte is subject to dilation, at step 430, to enhance detection of scratches which vary about the vertical direction. Inventive vertical rank thresholding is performed at step 440 and is followed at step 450 by morphological processing. Step 455 allows the steps 440 and 450 to be performed more than once to improve detection of meandering and or disconnected or discontinuous scratches. When a pixels vertical rank exceeds a pre-defined threshold it is flagged (step 460) as a suspect vertical scratch site in a defect binary matte. This defect matte is applied, together with the original corresponding input image, for repair at step 470 with the repaired image 490 being output for monitoring and recording at step 480.

FIG. 5 describes vertical rank thresholding. For each pixel a in the input binary matte, number n of pixels is calculated that (1) lie in the same vertical column within distance h/2 from a, and (2) flagged as suspected defect sites by the vertical defect detection process. Once a relative rank, defined as ratio n/h, exceeds a pre-defined threshold t, pixel a is flagged as a suspected site of vertical scratch in an output binary matte. As a result of the described procedure, flagged pixels tend to group into vertical patterns with characteristic height h.

Choosing threshold t=0.5 reduces vertical ranking to a widely used low-pass median filtering function. Threshold values from 0.6 to 0.95, which increase the detection threshold, have been found to be more useful for detecting visually significant vertical scratches.

For pixels that lie closer than h/2 to upper or lower boundary of the image, there is a choice between two useful algorithms. A first algorithm will consider one frame at a time. For pixel b close to upper edge of the image, the relative rank may be estimated from an asymmetrical segment of height h, which starts from the upper edge. This method will result in all pixels lying closer than h/2 to a horizontal boundary of the image in the same column be simultaneously either flagged or not flagged.

A second algorithm extends the segment to cover neighboring frames. This second algorithm is particularly applicable to sequences of digital images resulting from conventional scanning of motion picture film. This procedure converts film frames into successive digital files. A vertical scratch in a frame from this sequence will generally not be confined to a single frame but will extend to adjacent frames. As illustrated in FIG. 5, relative rank for pixel c is calculated over a vertical segment, which covers parts of both the current and next frame. It is possible to set the segment height h larger than the image height in order to enforce a requirement that vertical scratches shall persist in more than one consecutive frame.

A procedure for calculating vertical rank may be implemented very efficiently using known programming techniques. Once a rank n for one pixel is calculated, calculation for the next pixel in the same column requires only one conditional decrement and one conditional increment of n. Thus the vertical rank calculation results in a low computational complexity algorithm which accelerates processing speed and enhances operation of inventive scratch detection application.

In addition, operational experience with the inventive thresholding arrangements has validated a correlation between an operator's visual perception and detection of scratches and those produced by the inventive detection arrangement described herein.

What is claimed is:

1. A method for detecting and repairing vertical scratches in a digital image, comprising the steps of:
detecting positions of pixels having a significant value deviation from a horizontally averaged value;
counting the number of detected positions within a pre-defined distance in the same vertical column containing the pixel;
flagging a pixel as a scratch site whenever the count of detected positions exceeds a pre-defined threshold; and,
morphologically processing a binary map of flagged pixels and repairing the flagged pixels.

2. The method of claim 1, wherein the detecting step includes low-pass vertical filtering the digital image, and high-pass horizontal filtering the resultant image.

3. The method of claim 1, wherein the counting step includes extending the vertical column to include adjacent images from the same image sequence.

4. The method of claim 1, wherein the morphological processing step includes performing one of dilation and erosion.

5. The method of claim 1, wherein the morphological processing step includes expanding the binary map to include pixels horizontally adjacent to the flagged pixels.
